(19) United States
(12) Patent Application Publication
(10) Pub. No.: US 2026/0039394 A1
(43) Pub. Date: Feb. 5, 2026

(54) FIBER-COUPLED SINGLE-ELEMENT BALANCED RECEIVER

(71) Applicant: Georgia Tech Research Corporation, Atlanta, GA (US)

(72) Inventor: Marcus Cicerone, Atlanta, GA (US)

(21) Appl. No.: 18/994,831

(22) PCT Filed: Jul. 20, 2023
(86) PCT No.: PCT/US2023/028200

§ 371 Date: Jan. 15, 2025

Related U.S. Application Data
(60) Provisional application No. 63/369,096, filed on Jul. 22, 2022.

(51) Int. Cl. H04B 10/67; H04B 10/69

(52) U.S. Cl. CPC H04B 10/67; H04B 10/691

(57) ABSTRACT

A single-element balanced receiver system that includes a beam splitter configured to receive a simple light and split the sample light into a target light and a reference light, a first optical fiber path configured to receive the target light, and a second optical fiber path having a different length than the first optical fiber path and configured to receive the reference light, and a light detector configured to receive the light from the first optical path and the second optical path at effectively same point on a surface of the light detector.

### CROSS-REFERENCE TO RELATED APPLICATIONS

This application claims the benefit of U.S. Provisional Application Ser. No. 63/369,096 filed on 22 Jul. 2022, which is incorporated herein by reference in its entirety as if fully set forth below.

### GOVERNMENT LICENSE RIGHTS

This invention was made with government support under Agreement No. DE-SC0022121 awarded by the Department of Energy. The government has certain rights in the invention.

### FIELD

The present invention generally relates devices and methods for implementing a single-element balanced receiver using fiber optical paths.

### BACKGROUND

Differential, balanced receivers have long been implemented in the process of sensitively detecting small light signals.

Previously implemented balanced receivers have used two carefully matched photodiodes to measure slightly different signals simultaneously and electronically canceling the common signal to isolate only the differential signal. Current designs for balanced receivers require closely matched light detector pairs. This design has two inherent disadvantages; performance is limited by imperfectly matched detectors and amplification electronics, and matching detectors and electronics is costly. Free-space single-element receiver designs ameliorate difficulties with matching detector and electronic pairs but are impractical if they require path-length differences of more than a few cm. In a free-space implementation, a large path length difference comes with a large footprint requirement. An additional problem that can occur with free-space single-element receiver designs is that they are sensitive to temperature drift and small air currents.

As a result, there remains a need for improved single-element receiver designs that refine current methods for detecting small light signals. The presently disclosed designs are aimed at providing an improved single-element balanced receiver using optical fiber paths.

### SUMMARY

In some examples, a single-element balanced receiver system is disclosed. The single-element balanced receiver system can include a beam splitter configured to receive a sample light and split the sample light into a target light comprising a signal of interest and a reference light, a first optical fiber path configured to receive the target light, a second optical fiber path having a different length than the first optical fiber path and configured to receive the reference light, and a light detector configured to receive the light from the first optical fiber path and the second optical fiber paths at effectively the same point on a surface of the light detector.

In some examples, the signal of interest can be equal to the difference between an intensity of the target light in the first optical fiber path and an intensity of the reference light in the second optical fiber path.

In some examples, the signal of interest can appear on a detector output of the light detector at a frequency (f) where f=c/(2*n*Δl+2*δl), where Δl is the difference in the length of the first optical fiber path and the second optical fiber path, and n is the refractive index of the fiber and δl is a small, adjustable difference in the free-space pathlength.

In some examples, the sample light can be pulsed and the optical fiber path length difference Al is set so that the signal of interest at the detector output frequency f appears at the pulse repetition rate R=f=c/(2*n*Δl+2*δl).

In some examples, the first optical fiber path and the second optical fiber path can be formed by a bifurcated bundle.

In some examples, the single-element balanced receiver can further include a light collection region configured to receive the target light and the reference light from the beam splitter, direct the target light to the first optical path, and direct the reference light to the second optical fiber path.

In some examples, the light collection region can include a first lens configured to receive the target light and focus the target light to the first optical fiber path and a second lens configured to receive the reference light and focus the reference light to the second optical fiber path.

In some examples, the light detector can be configured to receive the light from the first optical fiber path and the second optical fiber path at effectively the same point on a surface of the light detector.

In some examples, a light detector can include an optical element to focus both the target light and the reference light from the common end of the bifurcated fiber bundle to effectively the same point on the surface of the light detector.

In some examples, the single-element balanced receiver can be configured to achieve at least 50 dB common mode rejection ratio when the reference light and the target light is of sufficient intensity to overcome intrinsic noise of the detector.

In some examples, the single-element balanced receiver can be configured to achieve at least 50 dB common mode rejection ratio at a frequency greater than 150 kHz when the reference light and target light is of sufficient intensity to overcome intrinsic noise of the detector.

In some examples, the first optical fiber path and the second optical fiber path can be formed by independent optical fibers.

In some examples, the single-element balanced receiver system can further include a light detector region configured to receive the target light and the reference light from the beam splitter, direct the target light to the first optical fiber path, and direct the reference light to the second optical fiber path.

In some examples, the light collection region can include a first lens configured to receive the target light and focus the target light into the first optical fiber path and a second lens configured to receive the reference light and focus reference light into the second optical fiber path.

In some examples, the light detector can be configured to receive the light from the first optical fiber path and the second optical fiber path at effectively the same point on a surface of the light detector.

In some examples, the light detector can include optical elements to focus the target light and the reference light from the first optical fiber path and the second optical fiber path at effectively the same point on the surface of the light detector.

In some examples, the single-element balanced receiver can be configured to achieve at least 50 dB common mode rejection ratio when the reference light and the target light is of sufficient intensity to overcome intrinsic noise of the detector.

In some examples, the single-element balanced receiver can be configured to achieve at least 50 dB common mode rejection ratio at a frequency greater than 150 kHz when the reference light and target light is of sufficient intensity to overcome intrinsic noise of the detector.

In some examples, a method of determining a signal of interest is disclosed. The method can include receiving a sample light, splitting the sample light into a target light and a reference light, propagating the target light along a first optical fiber path, propagating the reference light along a second optical fiber path, the second optical fiber path having a length that is different than a length of the first optical fiber path, receiving the target light and the reference light from the first and second optical fiber paths, respectively, at a detector, and calculating the signal of interest based, at least in part, on the received target light and reference light at the detector.

In some examples, the method can include the signal of interest corresponding to a difference in an intensity of the target light and the reference light at the detector.

In some examples, the method can include the signal of interest appearing on an output of the detector at frequency (f) where f=c/(2*n*Δl+2*δl), where Δl is an difference in the length of the first optical fiber path and the second optical fiber path, and n is the refractive index of the first and second optical fiber paths and δl is a small, adjustable difference in the free-space pathlength.

In some examples, the method can include, the sample light being pulsed and the optical path length difference Δl is set so that the signal of interest at an output of the detector at frequency f appears at the pulse repetition rate R=f=c/(2*n*Δl+2*δl).

Other aspects and features of the present disclosure will become apparent to those skilled in the pertinent art, upon reviewing the following detailed description in conjunction with the accompanying figures.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 shows an exemplary representation of a single-element balanced receiver receiving pulsed light and a resulting output according to aspects of the present invention.

FIG. 2 shows an exemplary representation of a single-element balanced receiver system using a bifurcated fiber bundle according to aspects of the present invention.

FIG. 3 shows an exemplary representation of a single-element balanced receiver system using independent optical fibers according to aspects of the present invention.

FIG. 4 shows a flow diagram illustrating a method of determining a signal of interest in a sample light according to aspects of the present invention.

### DETAILED DESCRIPTION

The following detailed description is merely exemplary in nature and is not intended to limit the disclosure or the application and uses of the disclosure. Although the description of the disclosure is in many cases in the context of detecting small pulses of light, the disclosed invention can also be applied to non-pulsed light.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

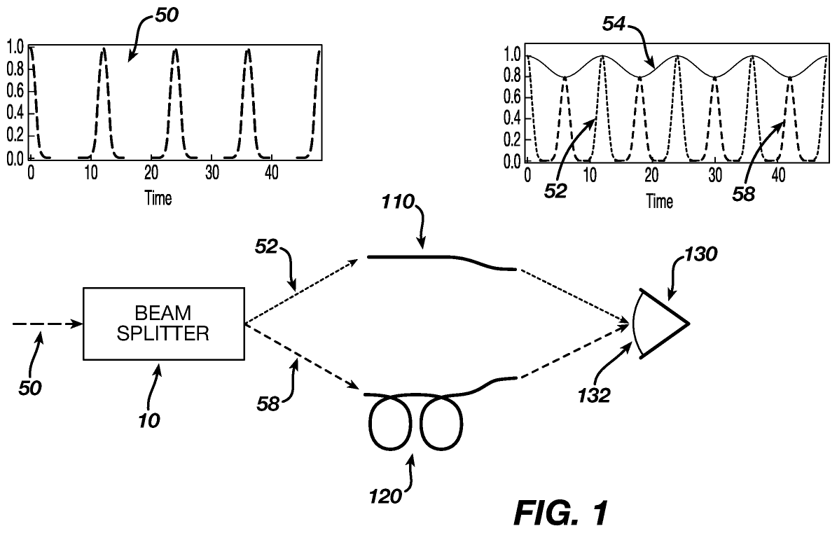

FIG. 1 illustrates an exemplary representation of a single-element balanced receiver 100 receiving pulsed light and a resulting output.

In some examples, the single-element balanced receiver 100 can include a beam splitter 10, a first optical fiber path 110, a second optical fiber path 120, and a light detector 130. The beam splitter 10 can be configured to receive a sample light 50 and split the sample light 50 into a target light 52 and a reference light 58. The target light 52 can comprise a signal of interest 54 (e.g., the signal of interest 54 can be embedded within the target light 52). The beam splitter 10 is not limited to any particular beam splitter, but, rather, can be many beam splitters known in the art. The first optical fiber path 110 can be configured to receive the target light 52 from the beam splitter 10. In some embodiments, the first optical fiber path 110 can receive the target light 52 directly or indirectly (e.g., via one or more lenses or other optical components) from the beam splitter 10. The second optical fiber path 120 can be configured to receive the reference light 58 from the beam splitter. In some embodiments, the second optical fiber path 120 can receive the reference light 58 directly or indirectly (e.g., via one or more lenses or other optical components) from the beam splitter 10. The first and second optical fiber paths 110 120 can comprise an optical fiber or optical fibers. The optical fiber can be many different optical fibers known in the art. In some embodiments, the optical fibers of the first and second optical fiber paths can have the same index of refraction. The light detector 130 can be many different light detectors known in the art capable of receiving light and measuring one or more properties of the light, e.g., amplitude, frequency, etc. In some embodiments, the light detector 130 can be configured to receive the target light 52 and reference light 58 from the first optical fiber path 110 and second optical fiber path 120, respectively, at effectively the same point on the light detector 132.

In some embodiments, the signal of interest 54 can be determined based, at least in part, on the propagation of the target light 52 and the reference light 58 in the first and second optic fiber paths. In some examples, the signal of interest 54 can be equal to the difference between an intensity of the target light 52 propagating through the first optical fiber path 110 and an intensity of the reference light propagating through the second optical fiber path 120. The signal of interest 54 can appear on a detector output of the light detector 130 at a frequency (f) where f=c/(2*n*Δl+2*δl). In some examples, Δl is the optical path difference in the length of the first and second optical fiber paths 110 120, and n is the refractive index of the fibers of the first and second optical fiber paths 110 120. In some examples, at the detector output of the light detector 130, the target light 52 and the reference light 58 each appear at repetition frequency R, but are interleaved and separated by a time of 1/(2 R).

In some examples, the difference in the free-space path length of the target light and the reference light can be adjusted by a small amount δl by any of the many known ways of doing so, such as changing the path length at any point where one of the lights is columnated.

In some examples, the sample light 50 can include light pulsed at a repetition frequency R and the optical path difference Δl is set so that the signal of interest 54 at the detector output frequency f appears at the pulse repetition rate R=f=c/(2*n*Δl+2*δl).

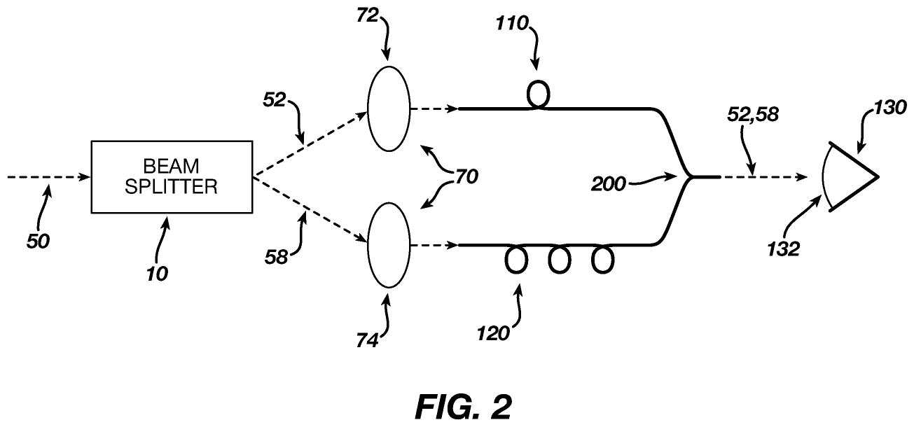

FIG. 2 illustrates an exemplary representation of a single-element balanced receiver 100 comprising a bifurcated fiber bundle.

In some examples, the single-element balanced receiver 100 can include a beam splitter 10 configured to receive a sample light 50 and split the sample light 50 into a target light 52 comprising a signal of interest 54 and a reference light 58, a first optical fiber path 110 configured to receive the target light 52, a second optical fiber path 120 having a different length than a length of the first optical fiber path 110 and configured to receive the reference light 58, and a light detector 130 configured to receive the target light 52 and reference light 58 from the first optical fiber path 110 and second optical fiber path 120 at effectively the same point on the light detector 130. In some examples, the light detector 130 can be configured to receive the target light 52 and the reference light 58 at effectively the same point on a surface 132 of the light detector 130.

In some examples, the single-element balanced receiver 100 can further include a light collection region 70 configured to receive the target light 52 and the reference light 58 from the beam splitter 10, direct the target light 52 to the first optical fiber path 110, and direct the reference light 58 to the second optical fiber path 120. The light collection region 70 can include a first lens 72 configured to receive the target light 52 and focus the target light 52 into the first optical fiber path 110. The light collection region 70 can also include a second lens 74 configured to receive the reference light 58 and focus the reference light 58 into the second fiber optical path.

In some examples, the light detector 130 can include an optical element (e.g., a lens) to focus the target light 52 and the reference light 58 from the common end 200 of the bifurcated fiber bundle to essentially the same point on the surface 132 of the light detector 130.

In some examples, the single-element balanced receiver 100 can be configured to achieve a Common Mode Rejection Ratio (CMRR) of at least 50 dB when the reference light 58 and the target light 52 are of an intensity sufficient to overcome the intrinsic noise of the light detector 130. The single-element balanced receiver 100 can further be configured to achieve a CMRR of at least 50 dB at a frequency of 150 kHz when the reference light 58 and the target light 52 are of an intensity sufficient to overcome the intrinsic noise of the light detector 130.

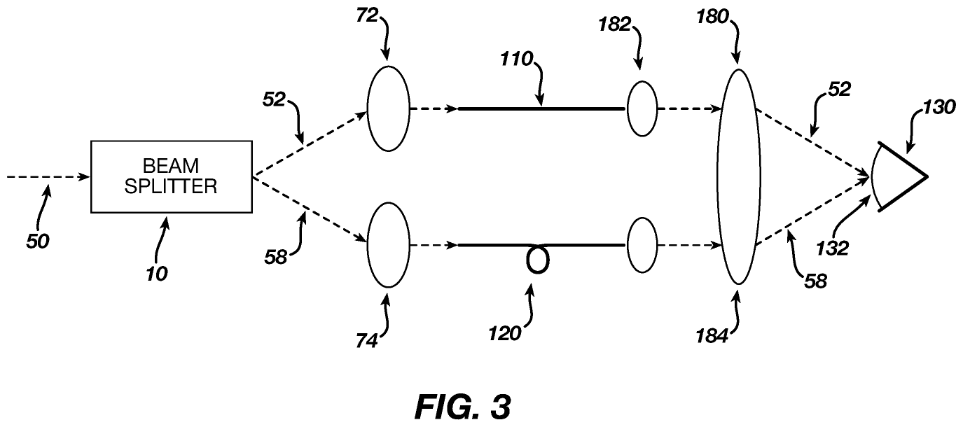

FIG. 3 illustrates an exemplary representation of a single-element balanced receiver 100 comprising independent optical fibers.

In some examples, the single-element balanced receiver 100 can include a beam splitter 10 configured to receive a sample light 50 and split the sample light 50 into a target light 52 comprising a signal of interest 54 and a reference light 58, a first optical fiber path 110 configured to receive the target light 52, a second optical fiber path 120 having a different length than a length of the first optical fiber path 110 and configured to receive the reference light 58, and a light detector 130 configured to receive the target light 52 and reference light 58 from the first optical fiber path 110 and second optical fiber path 120 at effectively the same point on the light detector 130. In some examples, the light detector 130 can be configured to receive the target light 52 and the reference light 58 at effectively the same point on a surface 132 of the light detector 130.

In some examples, the single-element balanced receiver 100 can further include a light collection region 70 configured to receive the target light 52 and the reference light 58 from the beam splitter 10, direct the target light 52 to the first optical fiber path 110, and direct the reference light 58 to the second optical fiber path 120. The light collection region 70 can include a first lens 72 configured to receive the target light 52 and focus the target light 52 into the first optical fiber path 110. The light collection region 70 can also include a second lens 74 configured to receive the reference light 58 and focus the reference light 58 into the second fiber optical path.

In some examples, the light detector 130 can include an optical element to focus the target light 52 and the reference light 58 from the common end 200 of the bifurcated fiber bundle to essentially the same point on the surface 132 of the light detector 130.

In some examples, the single-element balanced receiver 100 can be configured to achieve a Common Mode Rejection Ratio (CMRR) of at least 50 dB when the reference light 58 and the target light 52 are of an intensity sufficient to overcome the intrinsic noise of the light detector 130. The single-element balanced receiver 100 can further be configured to achieve a CMRR of at least 50 dB at a frequency of 150 kHz when the reference light 58 and the target light 52 are of an intensity sufficient to overcome the intrinsic noise of the light detector 130.

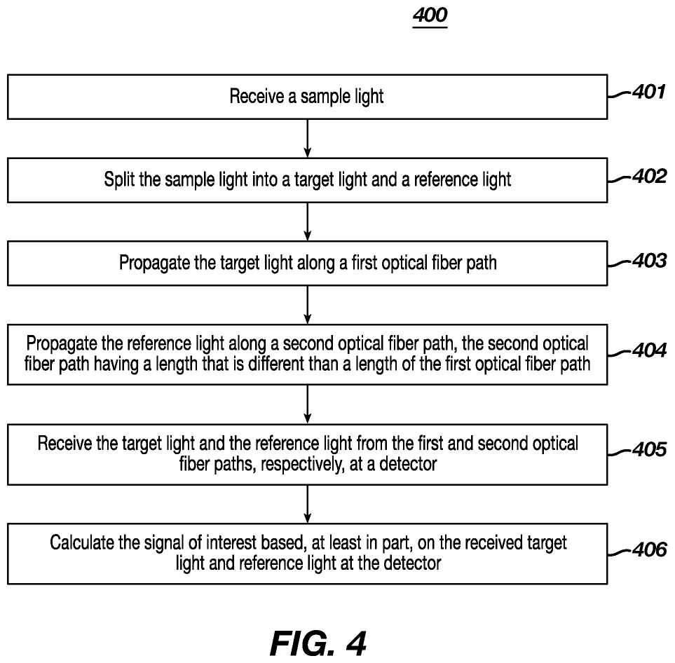

FIG. 4 illustrates a method 400 of determining a signal of interest 54 in a sample light 50 as disclosed herein. The method steps in FIG. 4 can be implements by any of the example means described herein or by similar means, as will be appreciated.

At block 401 the method 400 can include receiving a sample light 50.

At block 402 the method 400 can include splitting the sample light 50 into a target light 52 and a reference light 58.

At block 403 the method 400 can include propagating the target light 52 along a first optical fiber path 110.

At block 404 the method 400 can include propagating the reference light 58 along a second optical fiber path 120, the second optical fiber 120 path having a length that is different than a length of the first optical fiber path 110.

At block 405 the method 400 can include receiving the target light 52 and the reference light 58 from the first and second optical fiber paths 110 120, respectively, at a detector 130.

At block 406 the method 400 can include calculating the signal of interest 54 based, at least in part, on the received target light 52 and reference light 58 at the detector 130.

In some examples, the signal of interest 54 corresponds to a difference in an intensity of the target light 52 and the reference light 58 at the detector 130.

In some examples, the signal of interest 54 appears on an output of the detector 130 at frequency (f) where f=c/(2*n*Δl+2*δl), where Δl is a difference in the length of the first optical fiber path 110 and the second optical fiber path 120, and n is the refractive index of the first and second optical fiber paths 110 120 and δl is a small, adjustable difference in the free-space pathlength between 110 and 120.

In some examples, the sample light 50 is pulsed and the optical path length difference Δl is set so that the signal of interest 54 at an output of the detector 130 at frequency f appears at the pulse repetition rate R=f=c/(2*n*Δl+2*δl).

The descriptions contained herein are examples of embodiments of the invention and are not intended in any way to limit the scope of the invention. As described herein, the invention contemplates many variations and modifications of a single-element balanced receiver system, including implementations using a bifurcated fiber bundle as well as independent optical fibers. Modifications and variations apparent to those having skilled in the pertinent art according to the teachings of this disclosure are intended to be within the scope of the claims which follow.

1. A single-element balanced receiver system comprising:
a beam splitter configured to split a sample light into a target light comprising a signal of interest and a reference light;
a first optical fiber path configured to receive the target light;
a second optical fiber path configured to receive the reference light, the second optical fiber path having a different length than the first optical fiber path; and
a light detector configured to receive a detected signal comprising the target light from the first optical fiber path and the reference light from the second optical fiber path;
wherein the detected signal has at least one frequency component having an amplitude proportional to the signal of interest, from which the signal of interest is determinable

2. The single-element balanced receiver system of claim 1, wherein:
the light detector is further configured to receive the target light from the first optical fiber path and the reference light from the second optical fiber path at effectively the same point on the light detector; and
the signal of interest is equal to the difference between an intensity of the target light in the first optical fiber path and an intensity of the reference light in the second optical fiber path.

3. The single-element balanced receiver system of claim 1, wherein:
the signal of interest has a frequency (f)=c/(2*n*Δl+2+δl);
Δl is the difference in the length of the first optical fiber path and the second optical fiber path;
n is the refractive index of the fiber forming the first and second optical fiber paths; and
δl is an adjustable difference in a free-space pathlength between the first and second optical fiber paths.

4. (canceled)

5. A single-element balanced receiver system comprising:
a beam splitter configured to split a train of sample pulses at a repetition rate R into target pulses and reference pulses;
a first path comprising optical fiber configured to transmit the target pulses therethrough from an inlet to an output;
a second path comprising optical fiber configured to transmit the reference pulses therethrough from an inlet to an output; and
a light detector;
wherein:
the target pulses comprise a signal of interest;
the first path and the second path differ in length by Δl, which Δl differentially temporally delays the transmission of one of the target and reference pulses from the other of the target and reference pulses; and
the light detector is configured to receive the target and reference pulses from the outlets of the first and second paths at effectively the same point on the light detector.

6. The single-element balanced receiver system of claim 5, wherein at least one of:
each of the target and reference pulses from the outlets of the first and second paths have the repetition rate R, but are interleaved and separated by a time of 1/(2R);
the signal of interest is equal to a difference between an intensity of the target pulses in the first path and an intensity of the reference pulses in the second path;
the optical fiber of the first path and the second path comprises a bifurcated fiber bundle;
the signal of interest has a frequency (f)=c/(2*n*Δl+2+δl), where n is the refractive index of the optical fiber of the first and second paths, and δl is an adjustable difference in a free-space pathlength between the first and second paths; or
the single-element balanced receiver system further comprises a light collection region configured to receive the target pulses and the reference pulses from the beam splitter, direct the target pulses to the first path, and direct the reference pulses to the second path.

7. The single-element balanced receiver system of claim 6, wherein the light collection region comprises a first lens configured to receive the target pulses and focus the target pulses into the first path and a second lens configured to receive the reference pulses and focus the reference pulses into the second path.

8. (canceled)

9. The single-element balanced receiver system of claim 6, wherein the light detector comprises an optical element to focus the target pulses and the reference pulses from a common end of the bifurcated fiber bundle to essentially the same point on the surface of the light detector.

10. The single-element balanced receiver system of claim 6, wherein the single-element balanced receiver system is configured to achieve at least 50 dB common mode rejection ratio when the reference and target pulses are of sufficient intensity to overcome intrinsic noise of the light detector.

11. The single-element balanced receiver system of claim 6, wherein the single-element balanced receiver system is configured to achieve at least 50 dB common mode rejection ratio at a frequency greater than 150 kHz when the reference and target pulses are of sufficient intensity to overcome intrinsic noise of the light detector.

12. The single-element balanced receiver system of claim 5, wherein the optical fibers of the first are independent, discrete optical fibers.

13. The single-element balanced receiver system of claim 12 further comprising a light collection region configured to receive the target pulses and the reference pulses from the beam splitter, direct the target pulses to the first path, and direct the reference pulses to the second path.

14. The single-element balanced receiver system of claim 13, wherein the light collection region comprises a first lens configured to receive the target pulses and focus the target pulses into the first path and a second lens configured to receive the reference pulses and focus the reference pulses into the second path.

15. (canceled)

16. The single-element balanced receiver system of claim 12, wherein a light detector comprises optical elements to focus the target pulses and reference pulses from the respective optical fibers at the effectively same point on the surface of the light detector.

17. The single-element balanced receiver system of claim 12, wherein at least one of: the single-element balanced receiver system is configured to achieve at least 50 dB common mode rejection ratio when the reference and target pulses are of sufficient intensity to overcome intrinsic noise of the light detector; or
the single-element balanced receiver system is configured to achieve at least 50 dB common mode rejection ratio at a frequency greater than 150 kHz when the reference and target pulses are of sufficient intensity to overcome intrinsic noise of the light detector.

18. (canceled)

19. A method of determining a signal of interest in a sample light comprising:
receiving a sample light;
splitting the sample light into a target light and a reference light;
propagating the target light along a first optical fiber path;
propagating the reference light along a second optical fiber path, the second optical fiber path having a length that is different than a length of the first optical fiber path;
receiving the target light and the reference light from the first and second optical fiber paths, respectively, at a detector; and
calculating the signal of interest based, at least in part, on the received target light and reference light at the detector;
wherein:
the signal of interest appears on a detector output of the light detector at a frequency (f)=c/(2*n*Δl+2*δl);
Δl is the difference in the length of the first optical fiber path and the second optical fiber path;
n is the refractive index of the fiber forming the first and second optical fiber paths; and
δl is an adjustable difference in a free-space pathlength between the first and second optical fiber paths.

20. The method of claim 19, wherein the signal of interest corresponds to a difference in an intensity of the target light and the reference light at the detector.

21. (canceled)

22. The method of claim 19, wherein the sample light is pulsed and the optical path length difference Δl is set so that the signal of interest at an output of the detector at frequency f appears at the pulse repetition rate R=f=c/(2*n*Δl+2*δl).
